(19) United States
(12) Patent Application Publication
(10) Pub. No.: US 2012/0281203 A1
(43) Pub. Date: Nov. 8, 2012

(54) MEANS FOR DETECTING LUMINESCENT AND/OR LIGHT-SCATTERING PARTICLES IN FLOWING LIQUIDS

(75) Inventor: Christoph Hermansen, Kotzen (DE)

(73) Assignee: BAYER INTELLECTUAL PROPERTY GMBH, Monheim (DE)

(21) Appl. No.: 13/514,914

(22) PCT Filed: Dec. 6, 2010
(86) PCT No.: PCT/EP2010/068998

§ 371 Date: Jul. 19, 2012

(30) Foreign Application Priority Data
Dec. 11, 2009 (EP) 09015341.2

(51) Int. Cl. G01N 21/53; G01N 21/64

(52) U.S. Cl. 356/72

(57) ABSTRACT

The invention relates to a probe for detecting luminescent and/or light-scattering particles in flowing liquids, having a measurement cell containing a pipeline channel through which the liquid to be measured flows, at least one transparent window in a wall of the pipeline, at least one light source for producing a dimensioned excitation light beam, which excites, through the window, the luminescent and/or the light-scattering particles in the pipeline channel in an optically limited light volume, at least one detector, which records, through the window or through a further window, light emitted by the luminescent and/or the light-scattering particles, wherein the measurement cell is configured such that the dimensioned excitation light beam and the emitted light are orientated such that they are perpendicular to each other and each particle moves rectilinearly within the measurement volume parallel to the liquid stream at a fixed angle to the excitation light. The invention also relates to a method for detecting luminescent and/or light-scattering particles in flowing liquids and to the use of the probe according to the invention and of the method for online monitoring of a production plant, in particular of a plastics production plant or a wastewater treatment plant.

The invention relates to a probe and a method for detecting luminescent and/or light-scattering particles in liquids flowing in a pipeline.

In the production of plastics, it is critically important to monitor production processes in order to obtain early information relating to the product quality. It is especially the number of luminescent or fluorescent particles that is a critical quality factor for the applicability of the plastic in the production of finished products for optical applications, in particular optical storage media such as CD-ROM, DVDs, optical components, window materials etc.

Various methods for detecting luminescent particles in CD-ROMs are known from the prior art. By way of example, the finished plastics granules are melted, injection moulded into a CD and checked for luminescence. In a further method, the finished plastics granules are dissolved and filtered as a solution through a filter. Finally, the filtered particles are assessed by means of an electronic microscope.

These methods are obviously complex and do not allow online control during the production process.

There was therefore a demand for a means, which can detect all luminescent particles occurring in any given measurement volume in real time reliably and accurately in a liquid which is flowing in a pipeline for example from a production plant. At the same time, the design of the apparatus should be simple and robust, and be able to withstand in particular temperatures of up to 400° C. at a pressure of 40 bar.

Document WO 2006/136147 A2 describes an apparatus for detecting scatter-light particles using a depth-limited diffuser, in which the particles travelling past the apparatus in an optically limited measurement volume are detected by means of a camera. In this apparatus, uniform illumination without light convergence or divergence is achieved in the measurement volume, the measurement volume being narrowly limited in the depth by means of a depth-limited diffuser, such that only the particles flowing within this volume can be seen. Arranged orthogonal to the diffuser is a video camera, via the resolution of which only the two dimensions of that surface of the measurement volume which is aligned orthogonally to the video camera are described. Both particle counting and particle identification are possible owing to rapid, highly resolving image detection and storage with the aid of evaluation software. Here, it must be ensured between two images that 100% of the measurement volume is exchanged. Recording of the particles for a longer detection time is avoided in WO 2006/136147 A2 because particle counting and particle identification would no longer be reliable.

However, since the light emitted by luminescent particles typically has a low intensity, the detector often operates at its detection limit, with the result that the moving particles must be recorded over a relatively long detection time.

Proceeding from WO 2006/136147 A2 as the closest prior art, the object was thus to provide a means for detecting luminescent particles in a pipeline, which enables differentiation between the light emitted by the luminescent particles and the noise of the detector.

Document US 2008/0019658 describes a measurement probe for detecting luminescent liquids, wherein the walls of the measurement probe are comprised of a transparent through-flow waveguide. Placed at the lower end of the through-flow waveguide are one or more detectors, which register the emission light, collected by the through-flow waveguide, of the particles which are excited to luminescence. Particle detection is not possible here.

Document JP 2005-300375 A describes a probe for detecting light-scattering particles in flowing liquids, wherein the measurement cell has a pipeline channel, through which the liquid to be measured flows, a transparent window in a wall of the pipeline and at least one light source for producing a dimensioned excitation light beam that illuminates, through the window, the light-scattering particles in the pipeline channel, and also at least one detector recording electromagnetic radiation from the light-scattering particles through the window. However, since the measurement cell is not configured such that the dimensioned excitation light beam and the light emitted by the light-scattering particles are orientated perpendicular to each other, this apparatus does not enable illumination over a defined depth of focus. Accordingly, no image plane is illuminated which would enable an image of the pipeline to be recorded.

Document U.S. Pat. No. 6,309,886 B1 discloses a probe for detecting fluorescent particles in flowing liquids. In the probe, a liquid is transported through the entire diameter of a channel, the liquid is exposed to illumination using a light source such that a light plane perpendicular to the liquid stream with a defined depth of focus, i.e. a light volume, is produced. The fluorescent particles flowing past in the light volume are excited by the light beam and their emission light is registered by means of a CCD camera with predefined exposure time over a predetermined integration time. The integration time can be greater than the transit time or be matched to the transit time in order to improve the sensitivity of detection and the particle resolution. The liquid is removed by way of an outflow channel. In this apparatus, no particular care has been taken that each particle moves linearly within the measurement volume parallel to the liquid stream. Accordingly, methods for reducing the flow variations over the measurement region, in particular at the edge of the channel, are used to improve the analysis results. For this, various methods for image correction are proposed or only the central portion of the channel is recorded by the detector.

Starting from U.S. Pat No. 6,309,886 B1 as the closest prior art, the object was therefore to provide a means for detecting luminescent particles in a pipeline, which enables differentiating between the light emitted by the luminescent particles and the noise of the detector, which can monitor the entire pipeline in a simple manner and which can be matched to the parameters in a production plant.

The problem is solved by a probe for detecting luminescent and optionally light-scattering particles in flowing liquids, having a measurement cell containing the following elements:
a pipeline channel through which the liquid to be measured flows,
at least one transparent window in a wall of the pipeline,
at least one light source for producing a dimensioned excitation light beam, which excites, through the window, the luminescent and the light-scattering particles in the pipeline channel in an optically limited measurement volume,
at least one detector, which records, through the window or through a further window, electromagnetic radiation from the luminescent and optionally from the light-scattering particles,
   wherein the measurement cell is configured such that the dimensioned excitation light beam and the emitted light are orientated such that they are perpendicular to each other, each particle moves rectilinearly within the measurement volume parallel to the liquid stream, and the liquid stream flows at a fixed angle to the excitation light, wherein the liquid stream, the detector and the light source are situated in one plane (FIGS. 1, 3, 6b). According to the invention, the detector has an interface with an element for controlling the integration time, which serves for inputting the size of the sample volume and for inputting the flow speed and for calculating and controlling the integration time, so that the detector records the light emitted by the luminescent particles over the time a particle takes to flow through the light volume at the input flow speed.

In the present invention, the particles can be recorded over a relatively long detection time, i.e. continuously, while they continue to move in the flowing liquid.

In a further embodiment of the present invention, the detector records, over the integration time, a series of images which are added up over this time. The particle tracking over the series of images requires a camera which is more sensitive to light so that a particle is detected, but is considerably easier so that a particle will not be counted more than once, in particular in the case of a probe with prism window. In addition, the method has the advantage of reducing noise.

Every particle has a directional flow and can be recorded over a relatively long detection time as a light point or as a directed light track, which enables reliable image analysis.

Owing to the directional flow of each particle, caused by the configuration of the probe, complicated calibration or correction of the image is not necessary.

A first object of the present invention is therefore a probe for detecting luminescent and optionally light-scattering particles in flowing liquids, which probe has a measurement cell comprising the following elements:
a pipeline channel through which the liquid to be measured flows,
at least one transparent window in a wall of the pipeline,
at least one light source for producing a dimensioned excitation light beam, which excites, through the window, the luminescent and the light-scattering particles in the pipeline channel in an optically limited light volume,
at least one detector, which records, through the window or through a further window, electromagnetic radiation from the luminescent and optionally from the light-scattering particles,
an element for controlling the integration time, which serves for inputting the size of a sample volume and for inputting a flow speed and also for calculating and controlling an integration time, wherein the integration time is the time a particle takes to flow through the light volume at the input flow speed,
   wherein the measurement cell is configured such that the dimensioned excitation light beam and the emitted light are orientated such that they are perpendicular to each other,
   wherein each particle moves within the measurement volume parallel to the liquid stream, and the liquid stream flows at a fixed angle to the excitation light,
   wherein the liquid stream, the detector and the light source are situated in one plane and,
   wherein the detector has an interface with the element for controlling the integration time, so that the detector records the light emitted by the luminescent particles over the time a particle takes to flow through the light volume at the input flow speed.

The fixed angle of the particle stream to the excitation light is preferably within the range of 45 to 135 degrees.

In order to permit clear identification of a luminescent particle on the basis of the intensity of its emission light, this intensity is added up over a specific time—also referred to as integration time. The integration time is defined as the time a particle takes to flow through the sample volume at a fixed flow speed. In the present invention, the detector accordingly has an interface with an element for controlling the integration time, so that the detector records the light, emitted by the luminescent particles, over the time a particle takes to flow through the light volume at a defined flow speed. The element for controlling the integration time is typically part of a computer.

Typically, pipelines with a diameter of 0.5 to 50 mm, preferably 4 to 30 mm, are controlled with the apparatus according to the invention. It should be noted here that the detection resolution decreases as the pipeline diameter increases. Accordingly, the light sources and detectors must be matched to the pipeline diameter, or the loss in resolution must be compensated for using appropriate means such as for example high-resolution, light sensitive cameras, high-power light sources such as laser-light sources or xenon lamps.

The material of the pipeline is arbitrary; typically pipelines made of metal are used.

The light sources used for exciting luminescent particles are typically xenon lamps in combination with excitation filters, lasers with appropriate emission wavelength or high-power LEDs.

The luminescent particles are typically excited using the light beam at a wavelength of 400 to 500 nm.

The excitation light beam produced by the light source is typically injected through a window which is placed in the pipeline wall over the entire pipeline diameter of the pipeline channel. The dimensions of the excitation light beam define the optically limited measurement volume. Likewise, the entire pipeline diameter is recorded by the detector. The particular advantage here is that owing to the image recording of a small section (measurement volume) of a pipeline over time the entire content in a pipeline can be covered. If necessary, the geometry of the excitation light beam is arranged with the aid of cylindrical lenses or waveguide cross-section converters.

Typically, the perpendicular orientation of the dimensioned excitation light beam to the light emitted by the luminescent particles is ensured by a perpendicular orientation of the light source and of the detector with respect to each other. Alternatively, the necessary orientation of the respective light beams to each other can be achieved by means of prisms and mirrors.

In a first embodiment of the probe according to the invention, a transparent window for illuminating the pipeline channel (illumination window) with the excitation light and a further transparent window for recording the emission light by means of the detector (detection window) are located in the pipeline wall. In this special embodiment (see FIG. 1), the pipeline is bent at an angle of 90°. The illumination window is located on one side of the pipeline upstream of the bend and the detection window is located on the side of the pipeline immediately downstream of the bend, such that the detection window is open over the lower part of the pipeline duct and the detector records the liquid stream flowing towards said detector. This embodiment has the particular advantage that the stream is observed at a fixed angle of 0 degree with respect to the flow direction, and that each particle is correspondingly detected as a point, provided it moves rectilinearly perpendicular to the excitation light during the entire integration time.

It is advantageous in this embodiment of the invention if the light volume is at most twice as great as the depth-of-focus region of the detector; the excitation light beam is typically focused on a thickness of 100 μμm to 10 mm, preferably 150 μm to 3 mm. If the measurement volume is greater than the depth-of-focus region, the particles are no longer measured exactly. If the requirement is merely one of detecting events, the measurement volume should only be sufficiently great for collecting as much light as possible.

Since the angle of the pipeline influences the direction of the liquid stream in the line even upstream of the bend, it is advantageous if the configuration of the measurement cell rectilinearly supports the laminar flow of the particles unhindered within the measurement volume, i.e. without dead spaces and at constant speed. To this end, various means can be used individually or in combination with one another.

For example, the window pane is preferably mounted in the pipeline wall flush with the pipeline channel. The shape of the window is arbitrary, usually round with a diameter of 2 to 100 mm. Alternatively, a probe made of sapphire or quartz glass can be produced and attached to the pipeline.

For applicability in a plastics production plant, the windows must withstand the flow of a melt at a temperature of up to 400° C. and a pressure of 1 to 250 bar. The window is typically comprised of sapphire or quartz glass, preferably sapphire for its particular strength, has a thickness of 10 mm and has—as described for example in DE 102 01 541 A1, a conical shape. Due to pressure by means of a glass-metal seal, the window element can be mounted in the pipeline wall flush with the pipeline channel (FIG. 3).

It is also preferred if the distance d from the centre of the illumination window to the surface of the detection window is matched to the size of the pipeline for optimum flow of the particles (FIG. 4). Depending on field of use, it is also advantageous to match the distance d to the flow speed and the viscosity of the liquid under examination, in order to optimize the laminar flow within the measurement region.

It is also possible to configure the detection window such that dead spaces in the 90°-angle in the pipeline are as few and as small as possible. To this end, the configuration of the detection window can be matched, as shown for example in FIG. 5.

In a second embodiment of the probe according to the invention, the necessary orientation of the respective light beams with respect to each other is achieved using a prism. Typically, the measurement cell has in that case a single window which is inserted at the edge of the pipeline in the pipeline wall and has the prism as the window pane (FIGS. 5 and 6). Alternatively, a probe made of sapphire or quartz glass with the appropriate prism geometry can be produced and attached to the pipeline.

This particular embodiment has the advantage that the liquid stream can flow past the window unhindered. The positioning of the light source, the detector and the geometry and optical characteristics of the prism ensure the appropriate perpendicular orientation of the excitation light to the emission light. Observation takes place at a fixed angle of preferably 45° or 135° to the flow direction. In this embodiment, the particle is recorded as a directional line.

In the case of the prism configuration, the thickness of the excitation light beam is preferably thinner than the diameter of the pipeline. Advantageous is a thickness of no more than 5 mm, preferably 150 μm to 3 mm, but this depends on the diameter of the flow channel. For example, a light beam thickness of no more than 1 mm is preferred for a flow-channel diameter of 5 mm. If the measurement volume is greater than the depth-of-focus region, the particles are no longer measured exactly. If the requirement is merely one of detecting events, the measurement volume should only be sufficiently great for collecting as much light as possible.

For the embodiments 1 and 2 described, it may be advantageous for the temperature of the measurement cell to be controlled directly by means of heating elements, with the result that the temperature of the liquid flowing past can be kept constant. Typical heating elements are oil trace heating via heating channels or electrical heating.

In the present invention, the detector can usually register the intensity of the light emitted by the luminescent particles at a wavelength of 500 to 700 nm. If the intensity of the light emitted by the light-scattering particles is registered by the detector, this usually takes place at the excitation wavelength. If necessary, emission filters are used to selectively detect this wavelength range. It is also possible to use a plurality of detectors, wherein detectors for detecting luminescent particles and detectors for detecting light-scattering particles can be combined (e.g. as shown in FIG. 10).

Possible detectors are, for example, CCD cameras, CMOS cameras, amplifier cameras, photomultipliers and photocells. Suitable cameras are those which are sufficiently light-sensitive in the detection wavelength range (500-700 nm). For example, the Stingray camera from AVT (image frequency 9 to 84 fps depending on model) is used. The advantage of a camera is that it not only detects the luminescence intensity of the particles but also their surfaces.

According to the invention, the light source irradiates the sample volume of the flow channel continuously or over the integration time and excites the particles flowing past.

Typically, the integration time is matched to the size of the sample volume and to the flow speed.

The detector records the emission light from the channel interior over the integration time and transmits this information to an image analysis unit, which is usually part of a computer.

The image material is typically analysed according to the chart in FIG. 7, the data are assessed and output.

Another object of the present invention is therefore a method for detecting luminescent and optionally light-scattering particles in a liquid flowing through the probe according to the invention, with the following steps:
inputting the size of a light volume and inputting a flow speed and calculating the integration time in an element for controlling the integration time, with the integration time being the time a particle takes to flow through the light volume at the defined flow speed,
light excitation by a light source, for defining the light volume,
detection of emission radiation over the integration time by means of a detector,
analysis of the detection data by means of an image analysis unit,
outputting the number of particles and/or size distribution of particles and/or intensity distribution of particles per volume and/or per weight and/or outputting a collective image of luminescent particles over a specific time.

Another object of the present invention is the use of the probe according to the invention and/or the method according to the invention for online monitoring of a production plant, in particular plastics production plant, wastewater treatment plant.

FIGS. 1, 3 to 6 show possible embodiments of the apparatus according to the invention, without limiting them thereto.

FIGS. 2 and 7 and 11 show the sequence of the method according to the invention and the sequence of the image analysis in the image analysis unit, without limiting them thereto.

If a series of images is recorded over the integration time, the images can be added up before the image analysis in the image analysis unit and the analysis can be continued according to FIG. 7.

In this case, the image is the added-up image.
Alternatively, the image analysis unit can carry out an image analysis according to FIG. 11 and the adding up is carried out as part of the image analysis.

### FIGURES

FIG. 1: probe according to the invention with reference to the embodiment 1

FIG. 2: process chart

FIG. 3: embodiment 1

FIG. 4: optimization of distance d in embodiment 1

FIG. 5: window variant in embodiment 1

FIG. 6a: side view of embodiment 2 with the prism

FIG. 6b: plan view of embodiment 2 with the prism

FIG. 7: chart of the image analysis in the image analysis unit in the embodiment, in which the particles are recorded continuously over a relatively long detection time which is equal to the integration time

FIG. 8: output of the number of fluorescent particles per gram melt over time

FIG. 9: collective image of the fluorescent particles over 6 hours

FIG. 10: probe for the simultaneous detection of luminescent particles and light-scattering particles

FIG. 11: chart of the image analysis in the image analysis unit in the embodiment, in which a series of images is recorded over the integration time

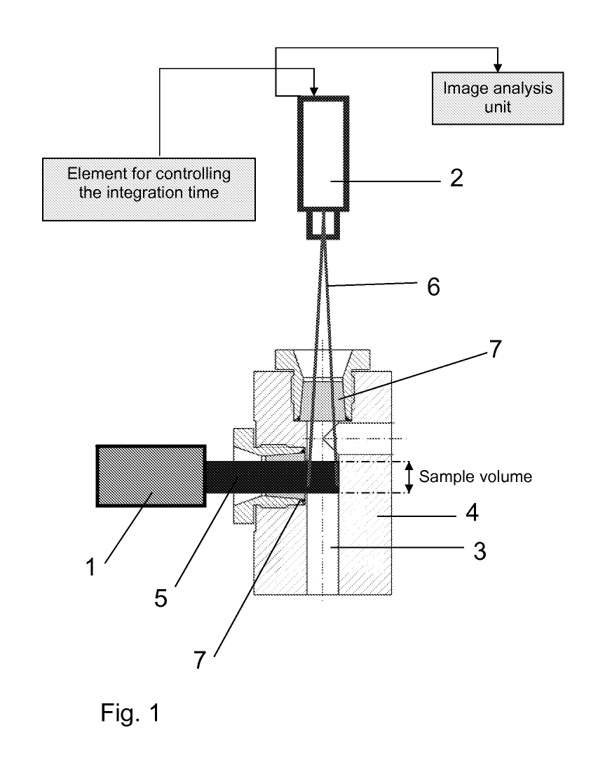

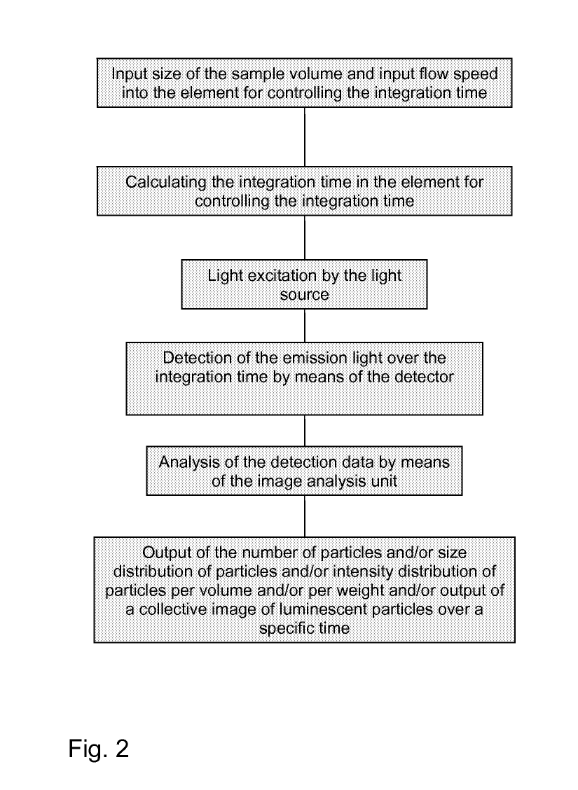

### REFERENCE SIGNS

1 light source
2 detector
2a detector for detecting luminescent particles
2b detector for detecting light-scattering particles
3 pipeline channel
4 pipeline wall
5 excitation light beam
6 emission light
7 window pane
8 glass-metal seal
9 aperture
10 prism
11 dichroic mirror 530 nm
12 excitation filter 400-500 nm
13 fluorescence filter 550-650 nm

### EXAMPLE

A pipeline with a pipeline channel of 8 mm diameter was bent at an angle of 90°.

In the pipeline wall, an illumination window was milled on one side of the pipeline upstream of the bend and a detection window was milled on the side of the pipeline immediately downstream of the bend, so that the detection window was open over the lower part of the pipeline duct and the detector could record the liquid stream flowing towards said detector.

The distance d from the centre of the illumination window to the surface of the detection window was 14 mm.

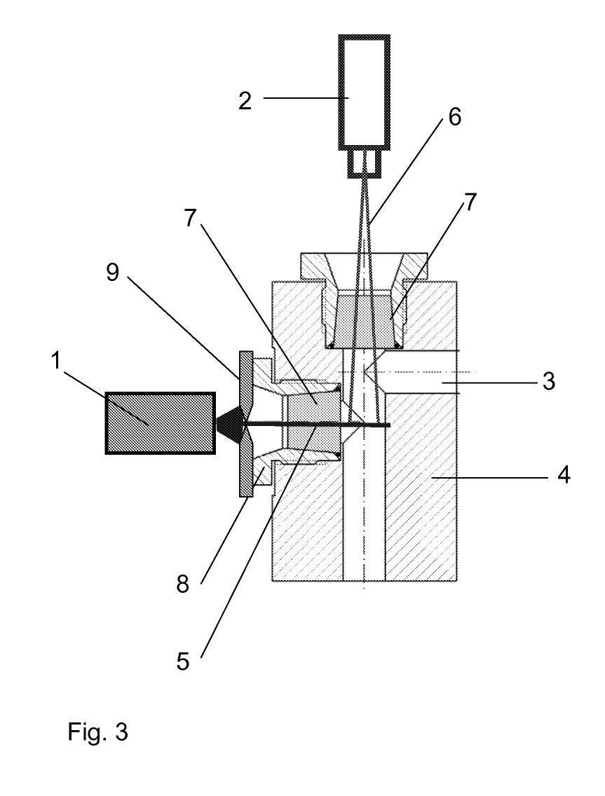

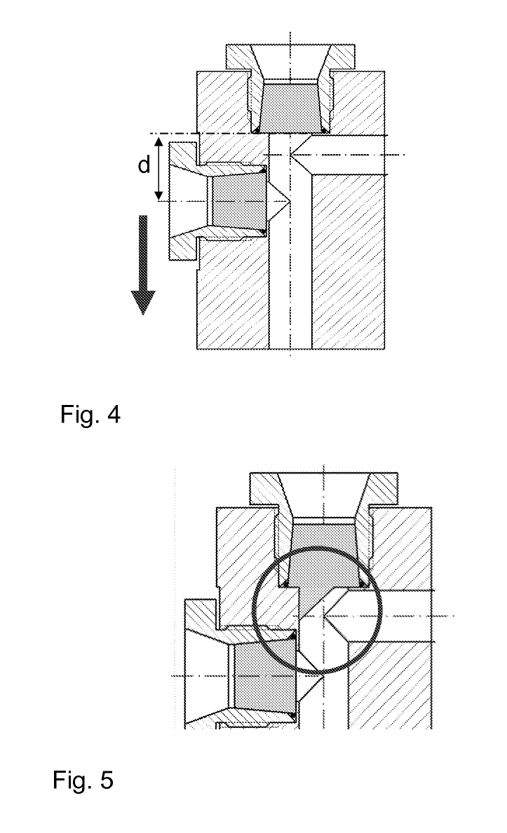

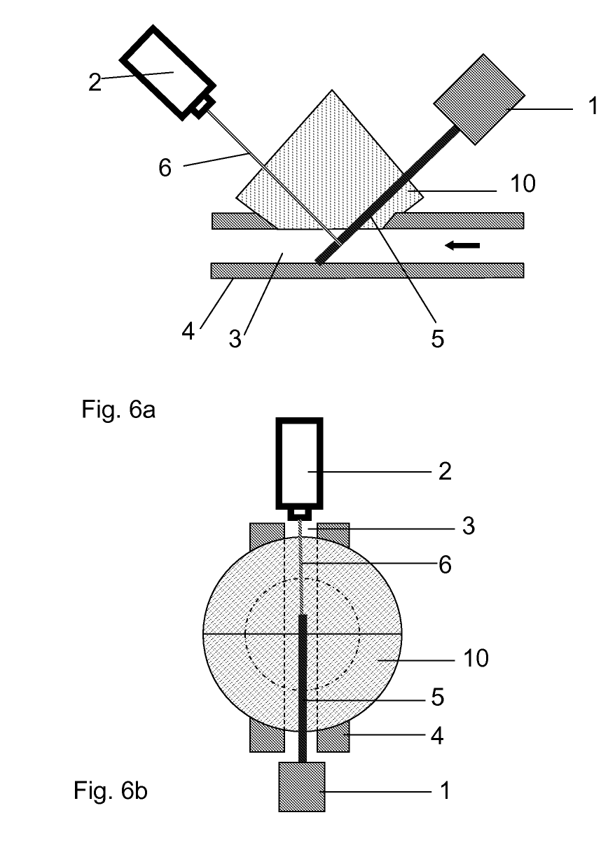

Both windows were round with a diameter of 9 mm. In each window, a conically shaped window pane made of sapphire, which was 10 mm thick, was mounted flush with the pipeline channel by way of pressure by means of a glass-metal seal (FIG. 3).

The probe was installed into the pipeline of a polycarbonate system, in which a polycarbonate melt flowed at a temperature of 300° C. at a flow speed of 6 m/min.

Mounted in front of the illumination window was a commercially available xenon lamp (Drelloscop 255, Drello) in combination with an excitation filter (HQ450/100 M-2P LOT Oriel) and an aperture. The excitation wavelength of the light beam was set with the aid of the excitation filter at 400-500 nm. The light beam was focused onto an average diameter of 2 mm by means of the aperture.

A camera (Stingray F-033B from AVT, up to 58 fps) in combination with an emission filter (HQ600/100M-2P from LOT Oriel) and a beam splitter (530DCXRU from LOT Oriel) was mounted in front of the detection window for selecting the recording in a wavelength range of 550 to 650 nm. The camera was mounted perpendicular to the excitation light, so that it could record the entire diameter of the pipeline channel.

The interface of the camera was connected to an element for controlling the integration time and to an image analysis unit, both being elements of a computer.

In the element for controlling the integration time, the size of the sample volume (2 mm) and the flow speed were input. An integration time of 20 ms was calculated. The light source illuminated the sample volume continuously at a wavelength of 400-500 nm.

The camera recorded images of the sample volume in a detection wavelength range of 550 to 650 nm over the integration time controlled by the element for controlling the integration time.

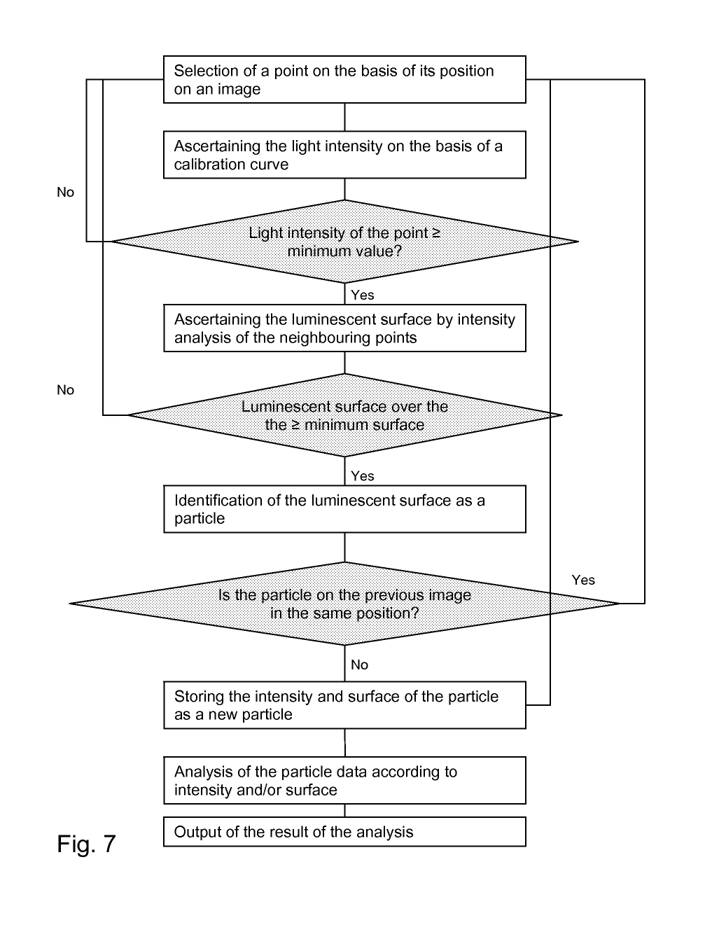

The recorded data were transmitted from the camera to the image analysis unit and were processed by the image analysis unit according to FIG. 7.

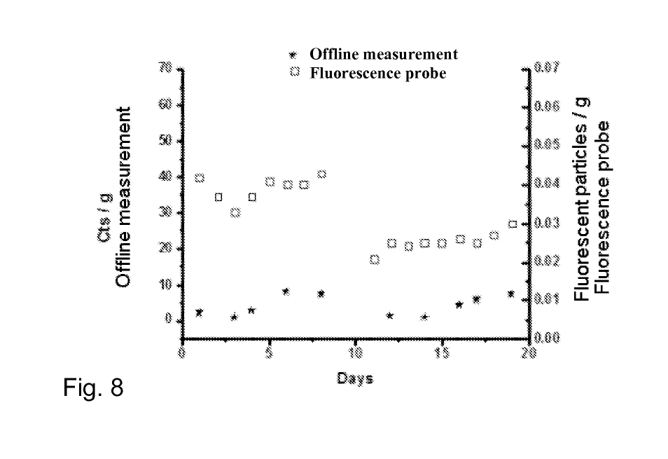

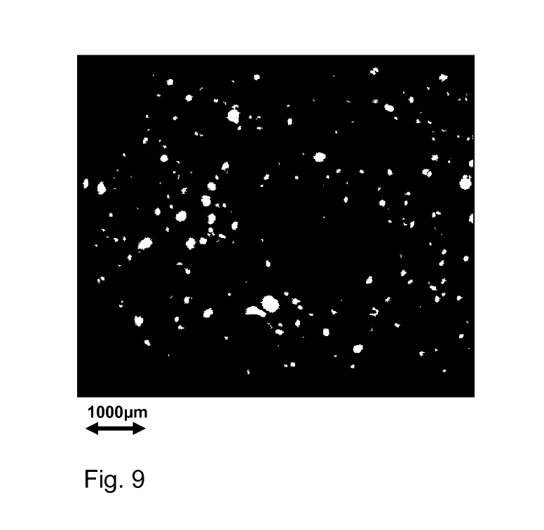

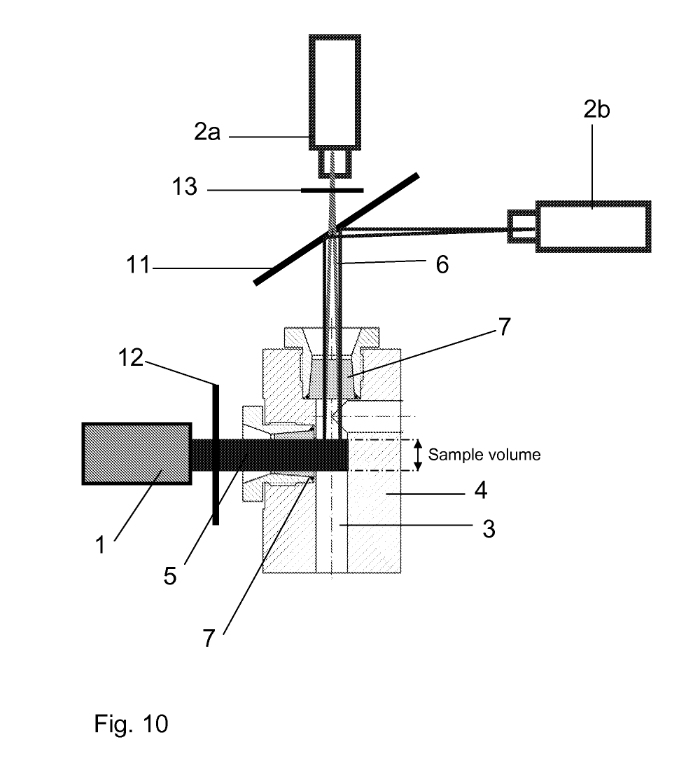

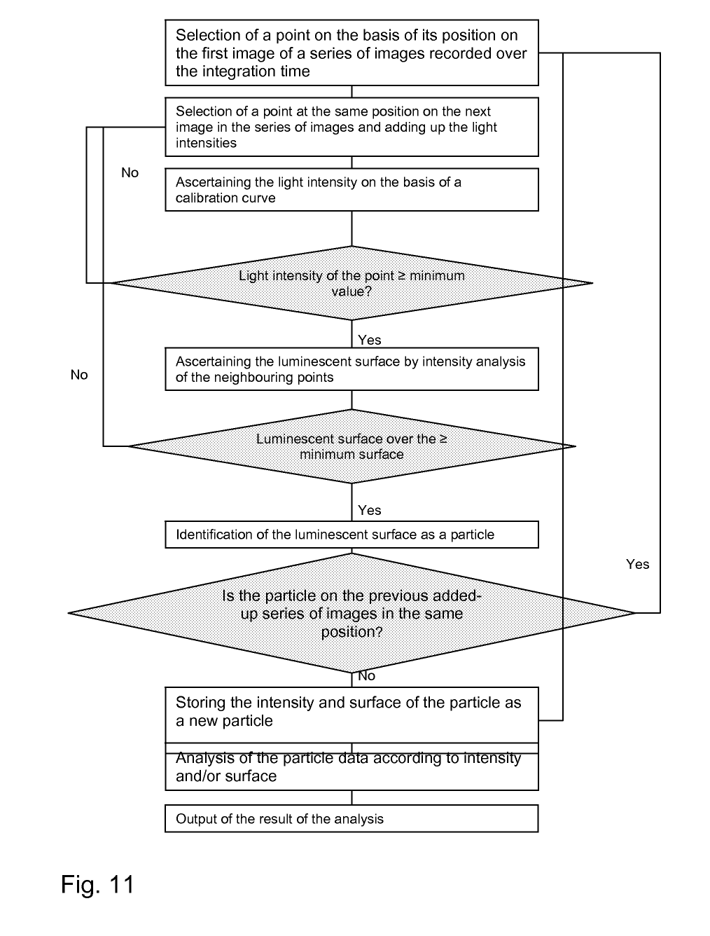

FIGS. 8 and 9 show possible outputs after processing of the data.

1. A probe for detecting luminescent and/or optionally light-scattering particles in a flowing liquid, having a measurement cell comprising:
a pipeline channel through which liquid to be measured flows,
at least one transparent window in a wall of the pipeline channel,
at least one light source for producing a dimensioned excitation light beam, which excites, through the window, the luminescent and the light-scattering particles in said pipeline channel in an optically limited light volume,
at least one detector, which records, through said at least one window or through a further window, electromagnetic radiation from said luminescent particles and optionally from said light-scattering particles,
an element for controlling integration time, which serves for inputting a size of a sample volume and for inputting a flow speed and for calculating and controlling integration time, said integration time being the time a particle takes to flow through the light volume at the flow speed,
wherein, in said measurement cell, said dimensioned excitation light beam and light emitted by said luminescent and/or said light-scattering particles are orientated such as to be perpendicular to each other,
wherein, each particle moves within the measurement volume parallel to a stream of liquid, and said liquid stream flows at a fixed angle to the excitation light,
wherein, said liquid stream, said detector and said light source are situated in one plane and,
wherein, said detector has an interface with the element for controlling said integration time, so that said detector can record light emitted by said luminescent particles over calculated integration time.

2. The probe according to claim 1, wherein a fixed angle of the particle stream to the excitation light is in a range of 45 to 135 degrees.

3. The probe according to claim 1, wherein said excitation light beam radiates in over an entire pipeline diameter of the pipeline channel.

4. The probe according to claim 1, wherein said pipeline is bent at an angle of 90 degrees and said pipeline has a transparent illumination window for illuminating said pipeline channel on one side of the pipeline upstream of a bend and has a transparent detection window for recording the emission light by means of the detector is located on the side of the pipeline immediately downstream of the bend, such that the detection window is open over a lower part of the pipeline channel and the detector records liquid stream flowing towards said detector.

5. The probe according to claim 4, wherein the distance from a centre of the illumination window to a surface of said detection window is matched to a size of said pipeline for optimum flow of particles.

6. The probe according to claim 4, wherein light volume is at most as great as twice a depth-of-focus region of an objective.

7. The probe according to claim 1, wherein said measurement cell has a single window which is inserted at an edge of said pipeline in a pipeline wall and has a prism as a window pane which ensures perpendicular orientation of the excitation light with respect to the emission light.

8. The probe according to claim 7, wherein a thickness of the excitation light beam is no more than 5 mm.

9. The probe according to claim 1, comprising a detector for luminescent particles and a detector for scatter-light particles.

10. A method for detecting luminescent and/or optionally light-scattering particles in a liquid flowing through the probe according to claim 1, comprising:
a. inputting a size of sample volume and inputting flow speed in said pipeline and calculating an integration time in an element for controlling said integration time, with said integration time being a time a particle takes to flow through said light volume at a defined flow speed,
b. exciting light over an entire pipeline diameter by a light source, for defining a light volume,
c. detection over an entire pipeline diameter of the emission light over said integration time by means of a detector,
d. analyzing detection data by means of an image analysis unit,
e. outputting a number of particles and/or size distribution of particles and/or intensity distribution of particles per volume and/or per weight and/or outputting a collective image of luminescent or light-scattering particles over a specific time.

11. The method according to claim 10, wherein light excitation and detection of the emission light take place over an entire pipeline diameter.

12. The method according to claim 11, wherein said detector is a high-resolution, light-sensitive camera.

13. The method according to claim 12, wherein said particles are recorded continuously over a relatively long detection time.

14. The method according to claim 13, wherein said detector records a series of images over the integration time, wherein said series of images is added up over said integration time.

15. The probe according to claim 1, capable of being used for online monitoring of a production plant optionally a plastics production plant or a wastewater treatment plant.

16. The method according to claim 11, capable of being used for online monitoring of a production plant, optionally a plastics production plant or a wastewater treatment plant.
